(19) United States
(12) Patent Application Publication
(10) Pub. No.: US 2012/0194381 A1
(43) Pub. Date: Aug. 2, 2012

(54) SYSTEM TO SECURELY CONTROL USE OF ELECTRONIC DEVICES IN AEROPLANES

(76) Inventor: Tai Cheung Poon, Hong Kong (HK)

(21) Appl. No.: 13/016,026

(22) Filed: Jan. 28, 2011

(51) Int. Cl. G01S 19/43; G01S 19/14

(52) U.S. Cl. 342/357.26; 342/357.52

(57) ABSTRACT

This invention is provided to securely control use of electronic devices in aeroplanes. In one embodiment, a system including a secured electronic device provided by an aeroplane for use in a passenger compartment in the aeroplane, whereas use of the device includes downloading information such as net surfing web pages and uploading information such as sending external emails. In the embodiment, the system includes a mobile equipment of a first customer and a mobile equipment of a second customer. The system also includes an outdoor GPS and indoor GPS receivers. Further, a set of three indoor GPS signal emitters are located on separate corners of the passenger compartment are provided. Besides, a GPS antenna, a repeater, and a secured control unit are installed inside the electronic device to include a preconfigured area as an insecure area.

### FIELD OF THE INVENTION

This invention generally relates to a system to securely control use of electronic devices in aeroplanes. This invention specifically relates to, but not limited to, a secured electronic device provided by an aeroplane for use in a passenger compartment in the aeroplane. Use of the device includes downloading information such as net surfing web pages and uploading information such as sending external emails; an outdoor GPS receiver connected to the aeroplane to locate GPS signals; an indoor GPS receiver connected to the electronic device. The indoor GPS receiver receives signals at a frequency other than L1 carrier signals adopted by the outdoor GPS receiver, for avoiding interference with outdoor GPS signals; a set of three indoor GPS signal emitters located on separate corners of the passenger compartment. Each indoor signal emitter having its own identifier represented by its unique C/A code sends data over a carrier signal at the frequency other than the L1 carrier signals adopted by the GPS for avoiding interference with outdoor GPS signals, the data including the location of the indoor GPS signal emitter and timestamp information where the data is sent; a GPS antenna located on the outside of the aeroplane to receive GPS signals; a GPS repeater located inside the aeroplane to broadcast GPS signals from outdoor environment to the passenger compartment in the aeroplane after receiving the GPS signals from the GPS antenna.

### BACKGROUND OF THE INVENTION

After several terrorists attack, aeroplane companies have been very careful about passenger safety. Aeroplane companies have been having a difficult time to control what passengers can bring on board. Among all the equipments that are brought on board, electronic equipments, such as iphone, ipad, and laptop computers, are of great concerns because many of them can be used as communication devices to receive and transmit information between the aeroplane and the outside world. It is, therefore, important to closely monitor the activities involving the use of these kinds of devices in aeroplanes.

From the above, it is desirable for airlines to provide aeroplanes tight security control over how electronic devices can be used in aeroplanes. Currently, there is no system to supply preconfigured electronic devices to users that allow them downloading and uploading information according to where the devices are on the aeroplane and where the aeroplane is from a geographic point. Such devices would provide new and unique services to passengers on board.

In view of the foregoing, there is a need to provide a system to securely control use of electronic devices in aeroplanes. From such a system, activities, especially on-line activities, can be closely monitored, with respect to what content is being accessed by what areas. More specifically, there is no system that can control the level of content with respect to the location of a given user inside the aeroplane.

### SUMMARY OF THE INVENTION

A system is provided to securely control use of electronic devices in aeroplanes. In one embodiment, a system includes a secured electronic device provided by an aeroplane for use in a passenger compartment in the aeroplane,. The use of the device includes downloading information such as net surfing web pages and uploading information such as sending external emails. Further, the inventive system includes an outdoor GPS receiver connected to the aeroplane to locate GPS signals; an indoor GPS receiver connected to the electronic device, where the indoor GPS receiver receives signals at a frequency other than L1 carrier signals adopted by the outdoor GPS receiver, for avoiding interference with outdoor GPS signals. The system further includes a set of three indoor GPS signal emitters located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent. Even further, the system includes a GPS antenna located on the outside of the aeroplane to receive GPS signals; a GPS repeater located inside the aeroplane to broadcast GPS signals from outdoor environment to the passenger compartment in the aeroplane after receiving the GPS signals from the GPS antenna; and a processing unit inside the electronic device.

In the embodiment, the processing unit may be configured to wirelessly process communication signals from the GPS repeater; based on the received signals from the GPS repeater, locate present position of the aeroplane; wirelessly receive carrier signals from the indoor GPS signal emitters; decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters; and authenticate access rights of the use of the device based on the present location of the aeroplane and the present position of the device within the passenger compartment of the aeroplane.

In another embodiment, the processor may be configured to wirelessly process communication signals from the GPS repeater. Based on the received signals from the GPS repeater, the processor may locate present position of the aeroplane; and wirelessly receive carrier signals from the indoor GPS signal emitters. The process may further decode the carrier signals to obtain the location of each of the GPS signal emitters and the timestamp information of the data received. Based on the speed of the carrier signals received from the GPS signal emitter, the timestamp information, and the location of the GPS signal emitters, the processor may further determine a distance from each of the GPS signal emitter to the electronic device; and calculate, based on triangulation principles, a present position of the device within the passenger compartment of the aeroplane, after collecting carrier signals from the set of three indoor GPS signal emitters. Access rights of the use of the device may then be authenticated based on the present location of the aeroplane and the present position of the device within the passenger compartment of the aeroplane, after confirming that both the location and the position are outside the insecure area.

On a different embodiment, the processor may also wirelessly process communication signals from the GPS repeater. Based on the receive signals from the GPS repeater, the processor may locate present position of the aeroplane; wirelessly receive carrier signals from the indoor GPS signal emitters. The processor may decode the carrier signals to obtain the location of each of the GPS signal emitters and the timestamp information of the data received. Based on speed of the carrier signals received from the GPS signal emitter, the timestamp information, and the location of the GPS signal emitters, the processor may determine a distance from each of the GPS signal emitter to the electronic device; calculate, based on triangulation principles, a present position of the device within the passenger compartment of the aeroplane, after collecting carrier signals from the set of three indoor GPS signal emitters; authenticate access rights of the use of the device based on the present location of the aeroplane and the present position of the device, wherein the device is permitted full access to download and upload data only if the present location of the aeroplane warrants access right of both uploading and downloading data; and the present position of the device within the passenger compartment of the aeroplane warrants access right of both uploading and downloading data.

In accordance to a different embodiment, a system is provided to securely control use of electronic devices in aeroplanes. A processing unit may be included inside the electronic device to wirelessly process communication signals from the GPS repeater; based on the receive signals from the GPS repeater, locate present position of the aeroplane; wirelessly receive carrier signals from the indoor GPS signal emitters; decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters; and authenticate access rights of the use of the device based on the present location of the aeroplane and the present position of the device, wherein if the present location of the aeroplane warrants access right of downloading data, the device is permitted to download the information such as net surfing web pages.

In yet another implementation, an inventive system may wirelessly process communication signals from the GPS repeater; based on the receive signals from the GPS repeater, locate present position of the aeroplane; wirelessly receive carrier signals from the indoor GPS signal emitters; decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters; and authenticate access rights of the use of the device based on the present location of the aeroplane and the present position of the device, wherein if the present location of the aeroplane warrants access right of downloading data but the present position of the device within the passenger compartment of the aeroplane fails to warrant access right of downloading data, the device is restricted to receive data, including downloading the information such as net surfing web pages.

In yet another embodiment, the inventive system may wirelessly process communication signals from the GPS repeater; based on the receive signals from the GPS repeater, locate present position of the aeroplane; wirelessly receive carrier signals from the indoor GPS signal emitters; decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters; and authenticate access rights of the use of the device based on the present location of the aeroplane and the present position of the device, where if the present location of the aeroplane warrants access right of downloading data but the present position within the passenger compartment of the aeroplane fails to warrant access right of downloading data, the device is restricted to receive data, including downloading the information such as net surfing web pages.

In another embodiment, a system is provided to wirelessly process communication signals from the GPS repeater; based on the receive signals from the GPS repeater, locate present position of the aeroplane; wirelessly receive carrier signals from the indoor GPS signal emitters; decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters; and authenticate access rights of the use of the device based on the present location of the aeroplane and the present position of the device within the passenger compartment of the aeroplane, wherein the device is permitted full access to download and upload data only if the present location of the aeroplane warrants access right of both uploading and downloading data; and the present position of the device within the passenger compartment of the aeroplane warrants access right of both uploading and downloading data; wherein if the present location of the aeroplane warrants access right of downloading data, the device is permitted to download the information such as net surfing web pages; wherein if the present location of the aeroplane fails to warrant access right of downloading data, the device is restricted to receive data, including downloading the information such as net surfing web pages; wherein if the present location of the aeroplane warrants access right of downloading data but the present position of the device within the passenger compartment of the aeroplane fails to warrant access right of downloading data, the device is restricted to receive data, including downloading the information such as net surfing web pages; and where if the present location of the aeroplane warrants access right of downloading data but the present position within the passenger compartment of the aeroplane fails to warrant access right of downloading data, the device is restricted to receive data, including downloading the information such as net surfing web pages.

### BRIEF DESCRIPTION OF THE DRAWINGS

FIG. 1 illustrates an exemplary system to securely control use of electronic devices in aeroplanes.

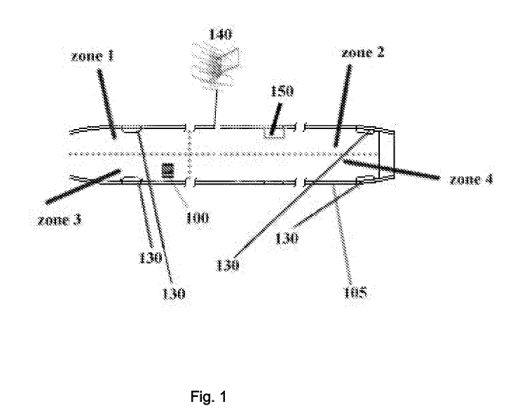

### DETAILED DESCRIPTION

Systems and methods are provided to securely control use of electronic devices in aeroplanes. Embodiments of the inventions may include a secured electronic device (100) provided by an aeroplane (105) for use in a passenger compartment in the aeroplane, whereas use of the device includes downloading information such as net surfing web pages and uploading information such as sending external emails. An outdoor GPS receiver (110) may be included to be connected to the aeroplane (105) to locate GPS signals. Likewise, an indoor GPS receiver (120) may be provided to be connected to the electronic device, where the indoor GPS receiver(120) receives signals at a frequency other than L1 carrier signals adopted by the outdoor GPS receiver, for avoiding interference with outdoor GPS signals. Also, a set of three indoor GPS signal emitters (130) may be included. Such emitters may be located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent. Further, a GPS antenna(140) is included, locating on the outside of the aeroplane (105) to receive GPS signals. Even further, a GPS repeater (150) can be located inside the aeroplane (105) to broadcast GPS signals from outdoor environment to the passenger compartment in the aeroplane (105) after receiving the GPS signals from the GPS antenna. Even more further, a processing unit may be included inside the electronic device to execute a series of steps. One step includes wirelessly processing communication signals from the GPS repeater (150). Based on the received signals from the GPS repeater (150), another step includes locating present position of the aeroplane. The step follows by wirelessly receiving carrier signals from the indoor GPS signal emitters (130). Further, the step includes decoding the carrier signals to obtain the location of each of the GPS signal emitters and the timestamp information of the data received. Based on speed of the carrier signals received from the GPS signal emitter, the timestamp information, and the location of the GPS signal emitters, the inventive system determines a distance from each of the GPS signal emitter to the electronic device; calculate, based on triangulation principles, a present position of the device within the passenger compartment of the aeroplane, after collecting carrier signals from the set of three indoor GPS signal emitters (130); and authenticate access rights of the use of the device based on the present location of the aeroplane (105) and the present position of the device within the passenger compartment of the aeroplane.

In an alternate example, a system to securely control use of electronic devices in aeroplanes is provided, including a secured electronic device(100) provided by an aeroplane (105) for use in a passenger compartment in the aeroplane, where use of the device includes downloading information such as net surfing web pages and uploading information such as sending external emails; an outdoor GPS receiver (110) connected to the aeroplane (105) to locate GPS signals; an indoor GPS receiver(120) connected to the electronic device, where the indoor GPS receiver(120) receives signals at a frequency other than L1 carrier signals adopted by the outdoor GPS receiver, for avoiding interference with outdoor GPS signals; a set of three indoor GPS signal emitters (130) located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent; a GPS antenna(140) located on the outside of the aeroplane (105) to receive GPS signals; a GPS repeater (150) located inside the aeroplane (105) to broadcast GPS signals from outdoor environment to the passenger compartment in the aeroplane (105) after receiving the GPS signals from the GPS antenna; a secured control unit installed inside the electronic device to include a preconfigured area as an insecure area, where the insecure area includes a geographic area that can be located by the outdoor GPS receiver (110) but the indoor GPS receiver(120); and an area within the passenger compartment that can be located by the indoor GPS receiver(120) but the outdoor GPS receiver; and a processing unit inside the electronic device to wirelessly process communication signals from the GPS repeater (150); based on the receive signals from the GPS repeater (150), locate present position of the aeroplane; wirelessly receive carrier signals from the indoor GPS signal emitters (130); decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters (130); and authenticate access rights of the use of the device based on the present location of the aeroplane (105) and the present position of the device within the passenger compartment of the aeroplane, after confirming that both the location and the position are outside the insecure area.

The inventive system can be further implemented to include other security features. In one embodiment, the system includes a secured electronic device(100) provided by an aeroplane (105) for use in a passenger compartment in the aeroplane, where use of the device includes downloading information such as net surfing web pages and uploading information such as sending external emails; an outdoor GPS receiver (110) connected to the aeroplane (105) to locate GPS signals; an indoor GPS receiver(120) connected to the electronic device, where the indoor GPS receiver(120) receives signals at a frequency other than L1 carrier signals adopted by the outdoor GPS receiver, for avoiding interference with outdoor GPS signals; a set of three indoor GPS signal emitters (130) located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent; a GPS antenna(140) located on the outside of the aeroplane (105) to receive GPS signals; a GPS repeater (150) located inside the aeroplane (105) to broadcast GPS signals from outdoor environment to the passenger compartment in the aeroplane (105) after receiving the GPS signals from the GPS antenna; a secured control unit installed inside the electronic device to include a preconfigured area as an insecure area, where the insecure area includes a geographic area that can be located by the outdoor GPS receiver (110) but the indoor GPS receiver(120); and an area within the passenger compartment that can be located by the indoor GPS receiver(120) but the outdoor GPS receiver; and a processing unit inside the electronic device to wirelessly process communication signals from the GPS repeater (150); based on the receive signals from the GPS repeater (150), locate present position of the aeroplane; wirelessly receive carrier signals from the indoor GPS signal emitters (130); decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters (130); authenticate access rights of the use of the device based on the present location of the aeroplane (105) and the present position of the device, wherein the device is permitted full access to download and upload data only if the present location of the aeroplane (105) warrants access right of both uploading and downloading data; and the present position of the device within the passenger compartment of the aeroplane (105) warrants access right of both uploading and downloading data.

In another embodiment of the present invention, an inventive system can wirelessly process communication signals from the GPS repeater (150); based on the receive signals from the GPS repeater (150), locate present position of the aeroplane; wirelessly receive carrier signals from the indoor GPS signal emitters (130); decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters (130); and authenticate access rights of the use of the device based on the present location of the aeroplane (105) and the present position of the device, wherein if the present location of the aeroplane (105) warrants access right of downloading data, the device is permitted to download the information such as net surfing web pages.

Other features are provided. One system includes using a secured electronic device(100) provided by an aeroplane (105) for use in a passenger compartment in the aeroplane, where use of the device includes downloading information such as net surfing web pages and uploading information such as sending external emails; an outdoor GPS receiver (110) connected to the aeroplane (105) to locate GPS signals; an indoor GPS receiver(120) connected to the electronic device, where the indoor GPS receiver(120) receives signals at a frequency other than L1 carrier signals adopted by the outdoor GPS receiver, for avoiding interference with outdoor GPS signals; a set of three indoor GPS signal emitters (130) located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent; a GPS antenna(140) located on the outside of the aeroplane (105) to receive GPS signals; a GPS repeater (150) located inside the aeroplane (105) to broadcast GPS signals from outdoor environment to the passenger compartment in the aeroplane (105) after receiving the GPS signals from the GPS antenna; a secured control unit installed inside the electronic device to include a preconfigured area as an insecure area, where the insecure area includes a geographic area that can be located by the outdoor GPS receiver (110) but the indoor GPS receiver(120); and an area within the passenger compartment that can be located by the indoor GPS receiver(120) but the outdoor GPS receiver; and a processing unit inside the electronic device to wirelessly process communication signals from the GPS repeater (150); based on the receive signals from the GPS repeater (150), locate present position of the aeroplane; wirelessly receive carrier signals from the indoor GPS signal emitters (130); decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters (130); and authenticate access rights of the use of the device based on the present location of the aeroplane (105) and the present position of the device, wherein if the present location of the aeroplane (105) fails to warrant access right of downloading data, the device is restricted to receive data, including downloading the information such as net surfing web pages.

The current invention may implemented with other features. A system to securely control use of electronic devices in aeroplanes, comprising a secured electronic device(100) provided by an aeroplane (105) for use in a passenger compartment in the aeroplane, where use of the device includes downloading information such as net surfing web pages and uploading information such as sending external emails; an outdoor GPS receiver (110) connected to the aeroplane (105) to locate GPS signals; an indoor GPS receiver(120) connected to the electronic device, where the indoor GPS receiver(120) receives signals at a frequency other than L1 carrier signals adopted by the outdoor GPS receiver, for avoiding interference with outdoor GPS signals; a set of three indoor GPS signal emitters (130) located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent; a GPS antenna(140) located on the outside of the aeroplane (105) to receive GPS signals; a GPS repeater (150) located inside the aeroplane (105) to broadcast GPS signals from outdoor environment to the passenger compartment in the aeroplane (105) after receiving the GPS signals from the GPS antenna; a secured control unit installed inside the electronic device to include a preconfigured area as an insecure area, where the insecure area includes a geographic area that can be located by the outdoor GPS receiver (110) but the indoor GPS receiver(120); and an area within the passenger compartment that can be located by the indoor GPS receiver(120) but the outdoor GPS receiver; and a processing unit inside the electronic device to wirelessly process communication signals from the GPS repeater (150); based on the receive signals from the GPS repeater (150), locate present position of the aeroplane; wirelessly receive carrier signals from the indoor GPS signal emitters (130); decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters (130); and authenticate access rights of the use of the device based on the present location of the aeroplane (105) and the present position of the device, wherein if the present location of the aeroplane (105) warrants access right of downloading data but the present position of the device within the passenger compartment of the aeroplane (105) fails to warrant access right of downloading data, the device is restricted to receive data, including downloading the information such as net surfing web pages.

In another example, a system is provided. The system may include a secured electronic device(100) provided by an aeroplane (105) for use in a passenger compartment in the aeroplane, where use of the device includes downloading information such as net surfing web pages and uploading information such as sending external emails; an outdoor GPS receiver (110) connected to the aeroplane (105) to locate GPS signals; an indoor GPS receiver(120) connected to the electronic device, where the indoor GPS receiver(120) receives signals at a frequency other than L1 carrier signals adopted by the outdoor GPS receiver, for avoiding interference with outdoor GPS signals; a set of three indoor GPS signal emitters (130) located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent; a GPS antenna(140) located on the outside of the aeroplane (105) to receive GPS signals; a GPS repeater (150) located inside the aeroplane (105) to broadcast GPS signals from outdoor environment to the passenger compartment in the aeroplane (105) after receiving the GPS signals from the GPS antenna; a secured control unit installed inside the electronic device to include a preconfigured area as an insecure area, where the insecure area includes a geographic area that can be located by the outdoor GPS receiver (110) but the indoor GPS receiver(120); and an area within the passenger compartment that can be located by the indoor GPS receiver(120) but the outdoor GPS receiver; and a processing unit inside the electronic device to wirelessly process communication signals from the GPS repeater (150); based on the receive signals from the GPS repeater (150), locate present position of the aeroplane; wirelessly receive carrier signals from the indoor GPS signal emitters (130); decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters (130); and authenticate access rights of the use of the device based on the present location of the aeroplane (105) and the present position of the device, where if the present location of the aeroplane (105) warrants access right of downloading data but the present position within the passenger compartment of the aeroplane (105) fails to warrant access right of downloading data, the device is restricted to receive data, including downloading the information such as net surfing web pages.

Another inventive system may be included to securely control use of electronic devices in aeroplanes, comprising a secured electronic device(100) provided by an aeroplane (105) for use in a passenger compartment in the aeroplane, whereas use of the device includes downloading information such as net surfing web pages and uploading information such as sending external emails; an outdoor GPS receiver (110) connected to the aeroplane (105) to locate GPS signals; an indoor GPS receiver(120) connected to the electronic device, where the indoor GPS receiver(120) receives signals at a frequency other than L1 carrier signals adopted by the outdoor GPS receiver, for avoiding interference with outdoor GPS signals; a set of three indoor GPS signal emitters (130) located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent; a GPS antenna(140) located on the outside of the aeroplane (105) to receive GPS signals; a GPS repeater (150) located inside the aeroplane (105) to broadcast GPS signals from outdoor environment to the passenger compartment in the aeroplane (105) after receiving the GPS signals from the GPS antenna; a secured control unit installed inside the electronic device to include a preconfigured area as an insecure area, where the insecure area includes a geographic area that can be located by the outdoor GPS receiver (110) but the indoor GPS receiver(120); and an area within the passenger compartment that can be located by the indoor GPS receiver(120) but the outdoor GPS receiver; and a processing unit inside the electronic device to wirelessly process communication signals from the GPS repeater (150); based on the receive signals from the GPS repeater (150), locate present position of the aeroplane; wirelessly receive carrier signals from the indoor GPS signal emitters (130); decode the carrier signals to obtain the location of each of the GPS signal emitters and the timestamp information of the data received; based on speed of the carrier signals received from the GPS signal emitter, the timestamp information, and the location of the GPS signal emitters, determine a distance from each of the GPS signal emitter to the electronic device; calculate, based on triangulation principles, a present position of the device within the passenger compartment of the aeroplane, after collecting carrier signals from the set of three indoor GPS signal emitters (130); and authenticate access rights of the use of the device based on the present location of the aeroplane (105) and the present position of the device within the passenger compartment of the aeroplane, wherein the device is permitted full access to download and upload data only if the present location of the aeroplane (105) warrants access right of both uploading and downloading data; and the present position of the device within the passenger compartment of the aeroplane (105) warrants access right of both uploading and downloading data; wherein if the present location of the aeroplane (105) warrants access right of downloading data, the device is permitted to download the information such as net surfing web pages; wherein if the present location of the aeroplane (105) fails to warrant access right of downloading data, the device is restricted to receive data, including downloading the information such as net surfing web pages; wherein if the present location of the aeroplane (105) warrants access right of downloading data but the present position of the device within the passenger compartment of the aeroplane (105) fails to warrant access right of downloading data, the device is restricted to receive data, including downloading the information such as net surfing web pages; and where if the present location of the aeroplane (105) warrants access right of downloading data but the present position within the passenger compartment of the aeroplane (105) fails to warrant access right of downloading data, the device is restricted to receive data, including downloading the information such as net surfing web pages.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A system to securely control use of electronic devices in aeroplanes, comprising:
a secured electronic device provided by an aeroplane for use in a passenger compartment in the aeroplane, whereas use of the device includes downloading information such as net surfing web pages and uploading information such as sending external emails;
an outdoor GPS receiver connected to the aeroplane to locate GPS signals;
an indoor GPS receiver connected to the electronic device, where the indoor GPS receiver receives signals at a frequency other than L1 carrier signals adopted by the outdoor GPS receiver, for avoiding interference with outdoor GPS signals;
a set of three indoor GPS signal emitters located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent;
a GPS antenna located on the outside of the aeroplane to receive GPS signals;
a GPS repeater located inside the aeroplane to broadcast GPS signals from outdoor environment to the passenger compartment in the aeroplane after receiving the GPS signals from the GPS antenna; and
a processing unit inside the electronic device to:
wirelessly process communication signals from the GPS repeater;
based on the received signals from the GPS repeater, locate present position of the aeroplane;
wirelessly receive carrier signals from the indoor GPS signal emitters;
decode the carrier signals to obtain the location of each of the GPS signal emitters and the timestamp information of the data received;
based on speed of the carrier signals received from the GPS signal emitter, the timestamp information, and the location of the GPS signal emitters, determine a distance from each of the GPS signal emitter to the electronic device;
calculate, based on triangulation principles, a present position of the device within the passenger compartment of the aeroplane, after collecting carrier signals from the set of three indoor GPS signal emitters; and
authenticate access rights of the use of the device based on the present location of the aeroplane and the present position of the device within the passenger compartment of the aeroplane.

2. A system to securely control use of electronic devices in aeroplanes, comprising:
a secured electronic device provided by an aeroplane for use in a passenger compartment in the aeroplane, where use of the device includes downloading information such as net surfing web pages and uploading information such as sending external emails;
an outdoor GPS receiver connected to the aeroplane to locate GPS signals;
an indoor GPS receiver connected to the electronic device, where the indoor GPS receiver receives signals at a frequency other than L1 carrier signals adopted by the outdoor GPS receiver, for avoiding interference with outdoor GPS signals;
a set of three indoor GPS signal emitters located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent;
a GPS antenna located on the outside of the aeroplane to receive GPS signals;
a GPS repeater located inside the aeroplane to broadcast GPS signals from outdoor environment to the passenger compartment in the aeroplane after receiving the GPS signals from the GPS antenna;
a secured control unit installed inside the electronic device to include a preconfigured area as an insecure area,
where the insecure area includes:
a geographic area that can be located by the outdoor GPS receiver but the indoor GPS receiver; and
an area within the passenger compartment that can be located by the indoor GPS receiver but the outdoor GPS receiver; and
a processing unit inside the electronic device to:
wirelessly process communication signals from the GPS repeater;
based on the receive signals from the GPS repeater, locate present position of the aeroplane;
wirelessly receive carrier signals from the indoor GPS signal emitters;
decode the carrier signals to obtain the location of each of the GPS signal emitters and the timestamp information of the data received;
based on speed of the carrier signals received from the GPS signal emitter, the timestamp information, and the location of the GPS signal emitters, determine a distance from each of the GPS signal emitter to the electronic device;
calculate, based on triangulation principles, a present position of the device within the passenger compartment of the aeroplane, after collecting carrier signals from the set of three indoor GPS signal emitters; and
authenticate access rights of the use of the device based on the present location of the aeroplane and the present position of the device within the passenger compartment of the aeroplane, after confirming that both the location and the position are outside the insecure area.

3. A system to securely control use of electronic devices in aeroplanes, comprising:
a secured electronic device provided by an aeroplane for use in a passenger compartment in the aeroplane, where use of the device includes downloading information such as net surfing web pages and uploading information such as sending external emails;
an outdoor GPS receiver connected to the aeroplane to locate GPS signals;
an indoor GPS receiver connected to the electronic device, where the indoor GPS receiver receives signals at a frequency other than L1 carrier signals adopted by the outdoor GPS receiver, for avoiding interference with outdoor GPS signals;
a set of three indoor GPS signal emitters located on separate corners of the passenger compartment, wherein each indoor signal emitter having its own identifier represented by its unique C/A code sends data over a carrier signal at the frequency other than the L1 carrier signals adopted by the GPS for avoiding interference with outdoor GPS signals, wherein the data includes the location of the indoor GPS signal emitter and timestamp information where the data is sent;
a GPS antenna located on the outside of the aeroplane to receive GPS signals;
a GPS repeater located inside the aeroplane to broadcast GPS signals from outdoor environment to the passenger compartment in the aeroplane after receiving the GPS signals from the GPS antenna;
a secured control unit installed inside the electronic device to include a preconfigured area as an insecure area,
where the insecure area includes:
a geographic area that can be located by the outdoor GPS receiver but the indoor GPS receiver; and
an area within the passenger compartment that can be located by the indoor GPS receiver but the outdoor GPS receiver; and
a processing unit inside the electronic device to:
wirelessly process communication signals from the GPS repeater;
based on the receive signals from the GPS repeater, locate present position of the aeroplane;
wirelessly receive carrier signals from the indoor GPS signal emitters;
decode the carrier signals to obtain the location of each of the GPS signal emitters and the timestamp information of the data received;
based on speed of the carrier signals received from the GPS signal emitter, the timestamp information, and the location of the GPS signal emitters, determine a distance from each of the GPS signal emitter to the electronic device;
calculate, based on triangulation principles, a present position of the device within the passenger compartment of the aeroplane, after collecting carrier signals from the set of three indoor GPS signal emitters;
authenticate access rights of the use of the device based on the present location of the aeroplane and the present position of the device, wherein the device is permitted full access to download and upload data only if
the present location of the aeroplane warrants access right of both uploading and downloading data; and
the present position of the device within the passenger compartment of the aeroplane warrants access right of both uploading and downloading data.

4. The system of claim 3, wherein the processing unit inside the electronic device to:
wirelessly process communication signals from the GPS repeater;
based on the receive signals from the GPS repeater, locate present position of the aeroplane;
wirelessly receive carrier signals from the indoor GPS signal emitters;
decode the carrier signals to obtain the location of each of the GPS signal emitters and the timestamp information of the data received;
based on speed of the carrier signals received from the GPS signal emitter, the timestamp information, and the location of the GPS signal emitters, determine a distance from each of the GPS signal emitter to the electronic device;
calculate, based on triangulation principles, a present position of the device within the passenger compartment of the aeroplane, after collecting carrier signals from the set of three indoor GPS signal emitters; and
authenticate access rights of the use of the device based on the present location of the aeroplane and the present position of the device,
wherein if the present location of the aeroplane warrants access right of downloading data, the device is permitted to download the information such as net surfing web pages.

5. The system of claim 3, wherein the processing unit inside the electronic device to:
wirelessly process communication signals from the GPS repeater;
based on the receive signals from the GPS repeater, locate present position of the aeroplane;
wirelessly receive carrier signals from the indoor GPS signal emitters;
decode the carrier signals to obtain the location of each of the GPS signal emitters and the timestamp information of the data received;
based on speed of the carrier signals received from the GPS signal emitter, the timestamp information, and the location of the GPS signal emitters, determine a distance from each of the GPS signal emitter to the electronic device;
calculate, based on triangulation principles, a present position of the device within the passenger compartment of the aeroplane, after collecting carrier signals from the set of three indoor GPS signal emitters; and
authenticate access rights of the use of the device based on the present location of the aeroplane and the present position of the device,
wherein if the present location of the aeroplane fails to warrant access right of downloading data, the device is restricted to receive data, including downloading the information such as net surfing web pages.

6. The system of claim 3, wherein the processing unit inside the electronic device to:
wirelessly process communication signals from the GPS repeater;
based on the receive signals from the GPS repeater, locate present position of the aeroplane;
wirelessly receive carrier signals from the indoor GPS signal emitters;
decode the carrier signals to obtain the location of each of the GPS signal emitters and the timestamp information of the data received;
based on speed of the carrier signals received from the GPS signal emitter, the timestamp information, and the location of the GPS signal emitters, determine a distance from each of the GPS signal emitter to the electronic device;
calculate, based on triangulation principles, a present position of the device within the passenger compartment of the aeroplane, after collecting carrier signals from the set of three indoor GPS signal emitters; and
authenticate access rights of the use of the device based on the present location of the aeroplane and the present position of the device,
wherein if the present location of the aeroplane warrants access right of downloading data but the present position of the device within the passenger compartment of the aeroplane fails to warrant access right of downloading data, the device is restricted to receive data, including downloading the information such as net surfing web pages.

7. The system of claim 3, wherein the processing unit inside the electronic device to:
wirelessly process communication signals from the GPS repeater;
based on the receive signals from the GPS repeater, locate present position of the aeroplane;
wirelessly receive carrier signals from the indoor GPS signal emitters;
decode the carrier signals to obtain the location of each of the GPS signal emitters and the timestamp information of the data received;
based on speed of the carrier signals received from the GPS signal emitter, the timestamp information, and the location of the GPS signal emitters, determine a distance from each of the GPS signal emitter to the electronic device;
calculate, based on triangulation principles, a present position of the device within the passenger compartment of the aeroplane, after collecting carrier signals from the set of three indoor GPS signal emitters; and
authenticate access rights of the use of the device based on the present location of the aeroplane and the present position of the device, where if the present location of the aeroplane warrants access right of downloading data but the present position within the passenger compartment of the aeroplane fails to warrant access right of downloading data, the device is restricted to receive data, including downloading the information such as net surfing web pages.

8. The system of claim 3, wherein the processing unit inside the electronic device to:
wirelessly process communication signals from the GPS repeater;
based on the receive signals from the GPS repeater, locate present position of the aeroplane;
wirelessly receive carrier signals from the indoor GPS signal emitters;
decode the carrier signals to obtain the location of each of the GPS signal emitters and the timestamp information of the data received;
based on speed of the carrier signals received from the GPS signal emitter, the timestamp information, and the location of the GPS signal emitters, determine a distance from each of the GPS signal emitter to the electronic device;
calculate, based on triangulation principles, a present position of the device within the passenger compartment of the aeroplane, after collecting carrier signals from the set of three indoor GPS signal emitters; and
authenticate access rights of the use of the device based on the present location of the aeroplane and the present position of the device within the passenger compartment of the aeroplane,
wherein the device is permitted full access to download and upload data only if
the present location of the aeroplane warrants access right of both uploading and downloading data; and
the present position of the device within the passenger compartment of the aeroplane warrants access right of both uploading and downloading data;
wherein if the present location of the aeroplane warrants access right of downloading data, the device is permitted to download the information such as net surfing web pages;
wherein if the present location of the aeroplane fails to warrant access right of downloading data, the device is restricted to receive data, including downloading the information such as net surfing web pages;
wherein if the present location of the aeroplane warrants access right of downloading data but the present position of the device within the passenger compartment of the aeroplane fails to warrant access right of downloading data, the device is restricted to receive data, including downloading the information such as net surfing web pages; and
where if the present location of the aeroplane warrants access right of downloading data but the present position within the passenger compartment of the aeroplane fails to warrant access right of downloading data, the device is restricted to receive data, including downloading the information such as net surfing web pages.
